(19) United States
(12) Patent Application Publication
(10) Pub. No.: US 2021/0054720 A1
(43) Pub. Date: Feb. 25, 2021

(54) FLOW CONTROL TOOL AND METHOD OF USE

(71) Applicant: D.D.M. ENTERPRISES, INC., Kalkaska, MI (US)

(72) Inventor: Donald Tinker, Alden, MI (US)

(21) Appl. No.: 16/549,501

(22) Filed: Aug. 23, 2019

(51) Int. Cl. E21B 34/14; F16K 11/07; F16K 17/40; F16K 1/14

(52) U.S. Cl. CPC E21B 34/14; F16K 11/0704; E21B 2034/002; F16K 17/403; F16K 1/14; F16K 17/406

(57) ABSTRACT

A flow control tool having a body, a sliding sleeve, at least one activation member, a flapper insert, and a retaining member. The body has a first body end, a second body end, and a flowbore. The sliding sleeve is disposed or otherwise positioned within the flowbore. The sliding sleeve is (initially, such as during assembly or prior to running) releasably connected with the body. The sliding sleeve may be movable to a locked position. During production or flowback, the flow control tool is maintained open and in situ.

### BACKGROUND

### Field of the Disclosure

This disclosure generally relates to tools used in oil and gas wellbores. More specifically, the disclosure relates to downhole tool configured to open and close a tube string positioned in a wellbore to produce hydrocarbons or other fluids. Embodiments of the disclosure may be used in vertical or directional wells, as well as cased or open-hole wellbores.

### Background of the Disclosure

A hydrocarbon-based economy continues to be a dominant force in the modern world. As such, locating and producing hydrocarbons continues to demand attention from the oil and gas (O&G) industry. A well or wellbore is generally drilled in order to recover valuable hydrocarbons and other desirable materials trapped in geological formations in the Earth, which are later refined into commercial products, such as gasoline or natural gas. A wellbore is typically drilled using a drill bit attached to the lower end of a “drill string.”

The drill string is a long string of sections of drill pipe that are connected together end-to-end. Drilling fluid (or “mud”) is pumped down to the drill bit, primarily to lubricate and cool the drill bit, and also carry drill cuttings back to the surface. In conventional drilling, the wellbore is drilled to a predetermined position, and then lined with a larger-diameter pipe (e.g., casing). To accomplish this, the drill string and the drill bit are removed from the wellbore (e.g., tripping). Once removed, the casing is lowered into the well and cemented in place.

The process of drilling a well typically includes a series of drilling, tripping, casing and cementing, and repeating as necessary. FIG. 1A shows a simplified view of a conventional drilling operation 100. A derrick 102 (or drilling rig) is configured to rotate a drill string 104 that has a drill bit 106 disposed at a lower end of the drill string 104. As it rotates, the drill bit 106 forms the wellbore 108. The rotation may be with the use of a top drive 110 (with elevator, drive frame, etc.). Similarly, when it is desired to trip the drill string 104 into or out of the wellbore 108, the drive 110 is lowered or raised. For any kind of servicing operation, the drill string 104 is moved into or out of the wellbore 108.

A production string is typically placed all the way into the lower end of the wellbore. Logically, the outside diameter of the production tubing is less than the diameter of the internal wellbore or production casing, thereby defining a tubular annulus.

To gain access to hydrocarbons, selected portions of the production tubing (and formation) is perforated. Common today to increase or enhance production is the use of hydraulic fracturing (i.e., “facing”) in the surrounding formations.

Fracing entails injection of fracturing fluids into a formation in openhole or via perforations or other openings in the casing at high pressures and rates to form a fracture(s) in the formation. For the best access to multiple or layered reservoirs, or a very thick hydrocarbon-bearing formation by hydraulic fracturing, multiple fracturing zones are established and stimulated in stages. Various methods have been utilized to achieve zonal isolation, although numerous drawbacks to the current methods exist.

A common method currently used to isolate a fracturing zone in multistage fracturing utilizes composite bridge plugs. According to this method, the deepest zone in the wellbore (or most distal in horizontal wellbores) is stimulated.

FIG. 1B illustrates a conventional plugging operation as part of system 110 that includes use of a plug 112 used for plugging a section(s) of the wellbore 108. The tool or plug 112 may be lowered into the wellbore 108 by way of workstring 105 (e.g., e-line, wireline, coiled tubing, tube string, etc.), as applicable.

In operation, forces are applied to slip(s) that move in relation to a body (of plug 112), which are driven against corresponding conical members. This movement axially compresses and/or radially expands a compressible member, and the slips, which results in these components being urged outward from the plug 112 to contact the (inner wall of) the casing. Oftentimes multiple sections are isolated by way of one or more additional plugs.

A specific zone of the formation may be isolated by the plug 112 being positioned above the perforations associated with the stimulated zone. The process is repeated in the next zone up the wellbore.

A disadvantage(s) of using one or more bridge plugs to isolate a fracture stimulated zone are the high cost and risk of complications associated with multiple trips into and out of the wellbore to position the plugs. For example, bridge plugs can become stuck in the wellbore and need to be drilled out at great expense. A further disadvantage is that the required wellbore cleanout operation may block or otherwise damage some of the successfully fractured zones.

It is naturally desirable to “flow back,” i.e., from the formation to the surface, the injected fluid, or the formation fluid(s); however, this is not possible until the previously set tool or its blockage is removed. Removal of tools (or blockage) usually requires a well-intervention service for retrieval or drill-through, which is time consuming, costly, and adds a potential risk of wellbore damage.

A tube string may include a tubing hanger supporting the production string. Multiple tubings may be disposed (e.g., concentrically) within the wellbore, which may be used to transfer formation fluids to the surface (wellhead, etc.).

One way of controlling flow is through a flow control tool. A problem with these tools is a narrow inner diameter (ID) that can result in high velocities and/or undesired pressure drop. In some circumstances when hydrates are present, the change in pressure may result in formation of solids through the tool.

Another issue is the removal of the tool itself, which may be necessary before production can occur.

The ability to increase efficiency and save operational time (and thus saving operational costs) leads to considerable competition in the marketplace. Achieving any ability to save time, or ultimately cost, leads to an immediate competitive advantage. Thus, there is a need in the art for a production system that does not require extensive time (or incur difficulties) or difficulty in achieving production. There are needs in the art for novel systems and methods for controlling a flow, and particularly through an improved flow control tool that provides a larger ID along with greater resiliency.

### SUMMARY

Embodiments of the disclosure pertain to a flow control tool for use in a wellbore. The flow control tool may have any of a body, a sliding sleeve, at least one activation member, a flapper insert, and a retaining member.

The body may have a first body end, a second body end, and a flowbore. The flowbore may extend from the first body end to the second body end. The body may have an annular inner body groove disposed on an inner body surface.

The sliding sleeve may be disposed or otherwise positioned within the flowbore. The sliding sleeve may be configured with a ball seat. The sliding sleeve may be (initially, such as during assembly or prior to running) releasably connected with the body. The sliding sleeve may be movable to a locked position.

The at least one activation member may be coupled with the sliding sleeve in a manner to keep the sleeve releasably connected with the body. The member may be configured to break once an activation load is reached.

The at least one flapper insert may be disposed within the body. The insert may have a (movable) flapper biased to a first flapper position.

The retaining member may be disposed around the sliding sleeve. The retaining member may be configured to maintain the sleeve in the locked position.

In operation or use, when the activation load is in or reaches a predetermined activation range, the at least on activation member may break. This may allow or otherwise result in the sliding sleeve (being able) to move toward the locked position. In aspects, the locked position may include the retaining member expanded into the inner body groove, and the movable flapper held open in a second flapper position.

The predetermined activation range may include a pressure or other load of about 1000 psi to about 5000 psi. The flow control tool further comprises a second activation member. Any activation member may be a shear pin. There may be another or second flapper insert.

Any embodiment of a flow control tool described herein may be used with a system, operation, method, etc. of the present disclosure.

Embodiments herein pertain to a method of operating or otherwise using a flow control tool as described herein. The method may include running or otherwise providing a workstring, tubestring, or the like into a wellbore. The tool may include: a body; a sliding sleeve; an at least one activation member; and at least one flapper insert; and a retaining member.

The body may have a first body end, a second body end, a flowbore. The flowbore may extend therebetween. The body may have an annular inner body groove disposed on an inner body surface.

The sliding sleeve may be disposed within the flowbore. The sliding sleeve may (such as at the outset of assembly, prior to running, etc.) be releasably coupled with the body. The sliding sleeve may be movable to a locked position. The sliding sleeve may have a ball seat formed therein.

The at least one activation member may be coupled with the sliding sleeve in a manner to keep the sleeve releasably connected with the body. The activation member may be configured to break once an activation load is reached. In embodiments, there may be a plurality of activations members, such as in the range of 2 to 6.

The flapper insert may include a movable flapper biased to a first flapper position.

The retaining member may be disposed around the sliding sleeve. The retaining member configured to maintain the sleeve in the locked position once it has been moved by a force.

The method may include flowing a drop ball through the tubestring to an engagement position with the ball seat.

The method may include providing sufficient enough fluid pressure (such as via a pump or other mover) against the drop ball (once it has seated) in order to reach the activation load on the at least one activation member. As a result, breaking the at least one activation member, wherein upon breaking, the sliding sleeve may move to the locked position, and also resulting in the movable flapper being moved to a second (open) flapper position.

The method may include disengaging or otherwise removing the drop ball from the ball seat, or waiting (allowing) for the same to happen through ordinary sequence, whereby the fluid is now able to flow through the flow control tool, while the sliding sleeve remains in the locked position. This may occur, for example, by the ball (at least partially) dissolving, and thus dislodging from the ball seat. Additionally or alternatively, a pressure below the tool being adequate to overcome the seating pressure, and urge the ball out of the seat.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1A is a side view of a process diagram of a conventional drilling operation for an oil and gas production system;

FIG. 1B is a side view of a process diagram of a conventional plugging operation;

FIG. 2A shows a longitudinal side cross-sectional component breakout view of a flow control tool according to embodiments of the disclosure;

FIG. 2B shows a longitudinal side cross-sectional component assembly view of a flow control tool according to embodiments of the disclosure;

FIG. 2C shows a longitudinal side cross-sectional view of a flow control tool in a flapper-open position according to embodiments of the disclosure;

FIG. 2D shows a longitudinal side cross-sectional view of the flow control tool with a ball removed according to embodiments of the disclosure;

FIG. 3A shows a side view of a production system having a flow control tool in a closed position according to embodiments of the disclosure;

FIG. 3B shows a close-up side view of the flow control tool of FIG. 3A according to embodiments of the disclosure;

FIG. 3C shows a side view of a production system having a flow control tool in an open position according to embodiments of the disclosure; and

FIG. 3D shows a close-up side view of the flow control tool of FIG. 3C according to embodiments of the disclosure.

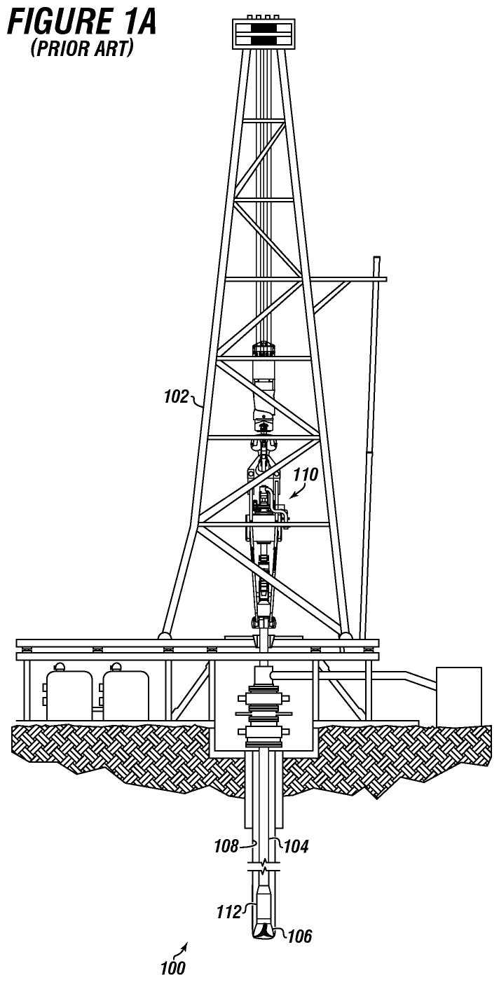

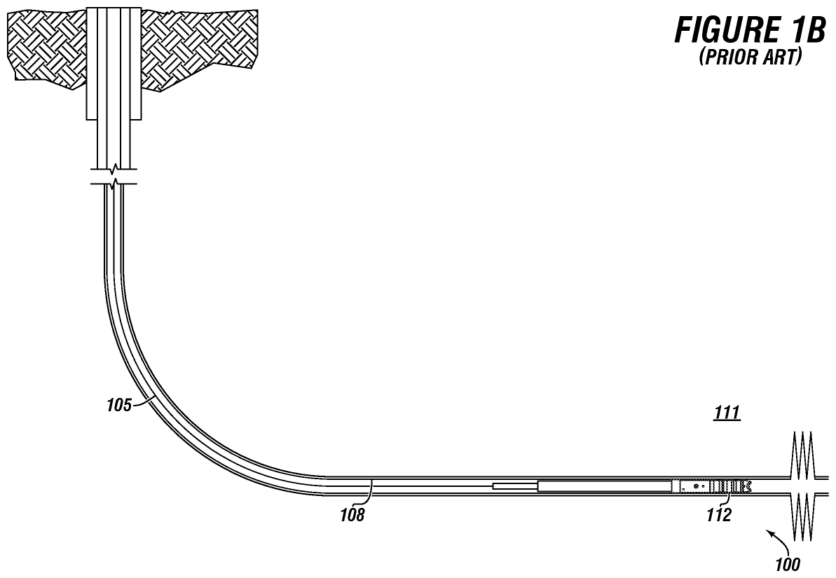

### DETAILED DESCRIPTION

Regardless of whether presently claimed herein or in another application related to or from this application, herein disclosed are novel apparatuses, units, systems, and methods that pertain to improved flowback control, details of which are described herein.

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any particular component, subcomponent, etc., may be as would be apparent to one of skill in the art, such as molding, forming, press extrusion, machining, or additive manufacturing. Embodiments of the disclosure provide for one or more components to be new, used, and/or retrofitted to existing machines and systems.

Various equipment may be in fluid communication directly or indirectly with other equipment. Fluid communication may occur via one or more transfer lines and respective connectors, couplings, valving, piping, and so forth. Fluid movers, such as pumps, may be utilized as would be apparent to one of skill in the art.

Numerical ranges in this disclosure may be approximate, and thus may include values outside of the range unless otherwise indicated. Numerical ranges include all values from and including the expressed lower and the upper values, in increments of smaller units. As an example, if a compositional, physical or other property, such as, for example, molecular weight, viscosity, melt index, etc., is from 100 to 1,000. it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure. Numerical ranges are provided within this disclosure for, among other things, the relative amount of reactants, surfactants, catalysts, etc. by itself or in a mixture or mass, and various temperature and other process parameters.

### Terms

The term “connected” as used herein may refer to a connection between a respective component (or subcomponent) and another component (or another subcomponent), which can be fixed, movable, direct, indirect, and analogous to engaged, coupled, disposed, etc., and can be by screw, nut/bolt, weld, and so forth. Any use of any form of the terms “connect”, “engage”, “couple”, “attach”, “mount”, etc. or any other term describing an interaction between elements is not meant to limit the interaction to direct interaction between the elements and may also include indirect interaction between the elements described.

The term “fluid” as used herein may refer to a liquid, gas, slurry, single phase, multi-phase, pure, impure, etc. and is not limited to any particular type of fluid such as hydrocarbons.

The term “fluid connection”, “fluid communication,” “fluidly communicable,” and the like, as used herein may refer to two or more components, systems, etc. being coupled whereby fluid from one may flow or otherwise be transferrable to the other. The coupling may be direct, indirect, selective, alternative, and so forth. For example, valves, flow meters, pumps, mixing tanks, holding tanks, tubulars, separation systems, and the like may be disposed between two or more components that are in fluid communication.

The term “pipe”, “conduit”, “line”, “tubular”, or the like as used herein may refer to any fluid transmission means, and may be tubular in nature.

The term “composition” or “composition of matter” as used herein may refer to one or more ingredients, components, constituents, etc. that make up a material (or material of construction). Composition may refer to a flow stream of one or more chemical components.

The term “chemical” as used herein may analogously mean or be interchangeable to material, chemical material, ingredient, component, chemical component, element, substance, compound, chemical compound, molecule(s), constituent, and so forth and vice versa. Any ‘chemical’ discussed in the present disclosure need not refer to a 100% pure chemical. For example, although ‘water’ may be thought of as H2O, one of skill would appreciate various ions, salts, minerals, impurities, and other substances (including at the ppb level) may be present in ‘water’. A chemical may include all isomeric forms and vice versa (for example, “hexane”, includes all isomers of hexane individually or collectively).

Reactive Material: as used herein may refer a material with a composition of matter having properties and/or characteristics that result in the material responding to a change over time and/or under certain conditions appreciably and predictably faster than a non-reactive material. The term reactive material may encompass degradable, dissolvable, disassociatable, and so on.

The term “water” as used herein may refer to a pure, substantially pure, and impure water-based stream, and may include waste water, process water, fresh water, seawater, produced water, slop water, treated variations thereof, mixes thereof, etc., and may further include impurities, dissolved solids, ions, salts, minerals, and so forth. Water for a frac fluid can also be referred to as ‘frac water’.

The term “frac fluid” as used herein may refer to a fluid injected into a well as part of a frac operation. Frac fluid is often characterized as being largely water, but with other constituents such as proppant, friction reducers, and other additives or compounds.

The term “produced fluid”, “production fluid”, and the like as used herein may refer to water, gas, mixtures, and the like recovered from a subterranean formation or other area near the wellbore. Produced fluid may include hydrocarbons or aqueous, such as flowback water, brine, salt water, or formation water. Produced water may include water having dissolved and/or free organic materials.

The term “skid” as used herein may refer to one or more pieces of equipment operable together for a particular purpose. For example, a ‘well tester skid’ may refer to one or more pieces of equipment operable to provide or facilitate a testing process related to a well. A skid may be mobile, portable, or fixed. Although ‘skid’ may refer to a modular arrangement of equipment, as used herein may be mentioned merely for a matter of brevity and simple reference, with no limitation meant. Thus, skid may be comparable or analogous to zone, system, subsystem, and so forth.

The term “skid mounted” as used herein may refer to one or more pieces operable together for a particular purpose that may be associated with a frame- or skid-type structure. Such a structure may be portable or fixed.

The term “pump” as used herein may refer to a mechanical device suitable to use an action such as suction or pressure to raise or move liquids, compress gases, and so forth. ‘Pump’ can further refer to or include all necessary subcomponents operable together, such as impeller (or vanes, etc.), housing, drive shaft, bearings, etc. Although not always the case, ‘pump’ can further include reference to a driver, such as an engine and drive shaft. Types of pumps include gas powered, hydraulic, pneumatic, and electrical.

The term “frac operation” as used herein may refer to fractionation of a downhole well that has already been drilled. ‘Frac operation’ can also be referred to and interchangeable with the terms fractionation, hydrofracturing, hydrofracking, fracking, fracing, and frac. A frac operation can be land or water based.

The term “utility fluid” as used herein may refer to a fluid used in connection with the operation of a heat generating device, such as a lubricant or water. The utility fluid may be for heating, cooling, lubricating, or other type of utility. ‘Utility fluid’ can also be referred to and interchangeable with ‘service fluid’ or comparable.

The term “mounted” as used herein may refer to a connection between a respective component (or subcomponent) and another component (or another subcomponent), which can be fixed, movable, direct, indirect, and analogous to engaged, coupled, disposed, etc., and can be by screw, nut/bolt, weld, and so forth.

The term “flowback” as used herein may refer to any fluid produced or otherwise flowed back from a formation.

The term “flapper” as used herein may refer to part or assembly of parts movable from a first position to a second position, and vice versa, akin to a ‘flap’.

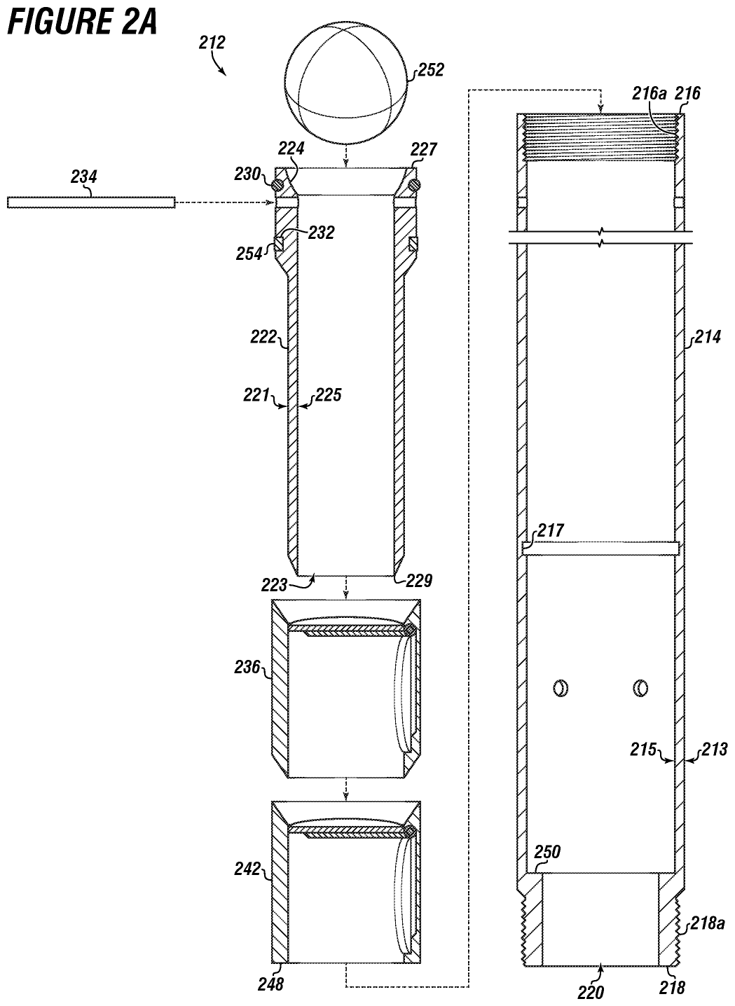

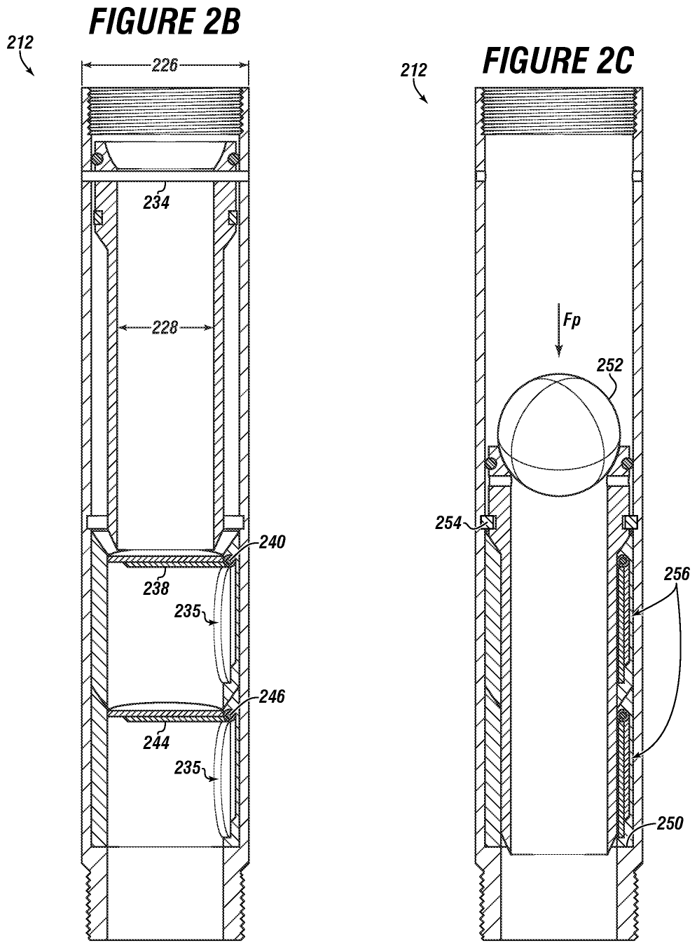

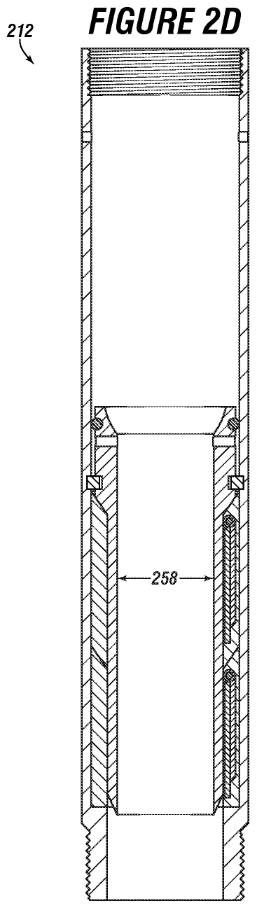

Referring now to FIGS. 2A-2D together, a longitudinal side cross-sectional component breakout view of a flow control tool, a longitudinal side cross-sectional component assembly view of a flow control tool, a longitudinal side cross-sectional view of a flow control tool in a flapper-open position, and a longitudinal side cross-sectional view of the flow control tool with a ball removed, illustrative of embodiments disclosed herein, are shown.

It should be appreciated that the flow control tool 212 may have one or more (sub)components made of non-composite material, such as a metal or metal alloys. The downhole tool 212 may have one or more components made of a reactive material (e.g., dissolvable, degradable, etc.). In embodiments, any (sub)components of the tool 212 may be made of dissolvable aluminum-, magnesium-, or aluminum-magnesium-based (or alloy, complex, etc.) material.

One or more components of tool 212 may be made of non-dissolvable materials (e.g., materials suitable for and are known to withstand downhole environments [including extreme pressure, temperature, fluid properties, etc.] for an extended period of time (predetermined or otherwise) as may be desired).

FIGS. 2A-2D together depict the flow control tool 212 that may be operable to achieve one or more above objectives as described herein. The flow control tool 212 may include a (tool) body 214. As shown, the body 214 may be tubular, but is not otherwise meant to be limited in shape.

The body 214 may be made of a material known to be useful in downhole conditions, such as metal or composite. In embodiments, the body 214 may be made of 4140 carbon steel, or an otherwise heat-treated metal.

The body 214 may have a first (or upper, proximate, etc.) end 216, and a second (or lower, distal, etc.) end 218. Either or both of the ends 216, 218 may be configured with a corresponding thread profile (e.g., 216a, 218a). The thread profile 216a, 218a may be male or female, or configured in whatever other manner makes the tool 212 useful for any given production system (and coupling with a respective tubestring).

The body 214 may have a flowbore 220 therethrough. As such, in embodiments, the body 214 may be a hollow tubular configured for coupling with a tubestring, whereby a fluid may (e.g., bi- or unidirectionally) flow through. The body 214 may have an outer body surface 211 and an inner body surface 213. The tool 212 (or body 214) may have an outer diameter 226. The outer diameter 226 may be in the range of about 2 inches to 5 inches. In embodiments, the outer diameter 226 may be about 3 inches to about 4 inches. The inner body surface 213 may have one or more inner body grooves 217. The inner body groove 217 may be annular in nature, and as such may be circumferential around (or otherwise disposed or formed in) the inner body surface 213. The groove 217 may be configured for receiving a device that may seat or engage therein.

Accordingly, the body 214 (or tool 212) may have one or more subcomponents, including being disposed therein or otherwise associated therewith. As shown, the tool 212 may include a sliding sleeve 222. The sliding sleeve 222 may be insertable, and thus releasably coupled with the body 214.

The sliding sleeve 222 may be tubular in nature, but need not be limited. Generally, the sliding sleeve 222 may be configured in a manner whereby the sleeve 222 may be slidable with respect to the body 214. The sliding sleeve 222 may have a sleeve bore 223, as well as an outer sleeve surface 221 and an inner sleeve surface 225. The sleeve bore 223 may have a sleeve bore inner diameter 228. The sleeve bore inner diameter 228 may be in a bore ID range of about 1.0 inches to about 2.5 inches. In embodiments, the range may be about 1.8 inches to about 2.0 inches. In other embodiments, the inner diameter 228 may be about 1.9 inches.

The sliding sleeve may have a ball seat (profile) 224 formed thereon, which may be proximate or at a first sleeve end 227. The ball seat 224 may be configured to receive a (drop) ball 252.

The sliding sleeve 222 may be disposed within the flowbore 220 (and thus within the body 214). The sliding sleeve 222 may be slidable, movable, etc. with respect to the body 214. In a first or assembled position, the sliding sleeve 222 may be held in place, albeit releasably coupled with the body 214. The first position may include one or more activation members 234 coupled between the body 214 and the sliding sleeve 222, whereby the sleeve 222 may be sufficiently held in place. In this respect, the tool 212 may be considered to be in a (valve-) closed position.

The body 214 may have one or more holes or grooves to accommodate placement of the activation member 234 therein. Similarly the sleeve 222 may have one or more holes or grooves corresponding thereto also to accommodate placement and holding of the activation member 234 therein.

The activation member 234 may be configured to break upon incurring a predetermined activation load. For example, the activation member 234 may be configured to break when the predetermined load is in a load range of about 1000 psi to about 5000 psi. The activation member 234 may be single load, double load, etc. Meaning the same member 234 may feel load at only a single break point, two break points (because of extending across the tool body), etc. There may be a plurality of activation members 234. The activation members 234 may be configured to break, shear, etc. The activation member 234 may be a shear pin or comparable.

The load may occur from fluid pressure Fp being urged against the ball (surface) 252. Pressure Fp may be increased until the pressure is in a fluid pressure range of about 1000 psi to about 5000 psi. In embodiments, the activation load may be about 2000 psi. The load against the ball 252 may be transferred to, or otherwise felt by, the activation member 234. In embodiments, the sleeve 222 may not move until the fluid pressure Fp results in an activation load in excess of the predetermined activation load. Once that point is reached, the activation member 234 may break, and the sleeve 222 may be urged to slide toward and engage with an at least one flapper insert 236.

In embodiments, the sliding sleeve 222 may be in a first position that may entail being releasably coupled with the body 214 via the activation member 234. In embodiments, the sliding sleeve 222 may be in a second position that may entail being coupled with the body 214 via a retaining member 254.

In the first position the retaining member 254 may be in compacted position that may facilitate the movability of the sleeve 222. The retaining member 254 may be positioned within sleeve groove 232. The retaining member 254 may be a space ring. The retaining member 254 may have sufficient resiliency and flexibility to be accommodate being compacted at the outset, and then expand or otherwise move into groove 217 (while still being at least partially in the sleeve groove 232.

When the sleeve 222 is in the second position, the retaining member 254 may expand or otherwise engage (move into contact with, etc.) the groove 217. As such, the sleeve 222 may now be held in place in the second position via the retaining member 254 being configured to hold the sleeve 222 while being coupled with the groove 217. The second position may entail a locked position, whereby with the sleeve 222 held in place, the tool 212 may be locked open. Thus, the tool 212 may be considered to be in an (valve-) open position.

This may occur because the sleeve 222 may be sufficiently urged down to a degree to compel the flapper 238 to open. In some embodiments, there may be a plurality of flappers, any of which configured to be open (and held open) upon engagement thereof by the sleeve 222.

As a result of being locked open and in place, the tool 212 (or any of its components) need not be removed and/or flown back to the surface—production may commence. Production may be readily improved as a result of the presence of a larger ID 258 through the tool.

The flapper insert 236 may be an annular body with a flapper bore therein, and being configured with flapper 238 coupled thereto. The flapper 238 may be movable about a pivot or rotation point 240. The flapper 238 may be coupled with the flapper body in a known manner, such as with a hinge and/or torsion spring. The flapper 238 may be biased to a first flapper (closed) position. The first flapper position may entail the closure of the bore of the flapper, and prevent or otherwise obstruct fluid from flowing through the tool 212. The flapper 238 may be generally flat (planar) in cross-section. While the shape of the flapper 238 need not be limited, the flapper 238 may be round or disc-shape, or other suitable shape to properly close the flapper bore (and thus close the tool).

In a second flapper (open) position the flapper 238 may be held in a flapper recess 235. As such, fluid may be free to flow through the tool 212. As shown in FIGS. 2C-2D, the sliding sleeve 222 may be moved to the second sleeve position that results in the sleeve 222 being positioned within the flapper bore, and urging the flapper 238 into the flapper recess 235. The flapper 238 may be a multipart piece comprising a first portion coupled with a second portion.

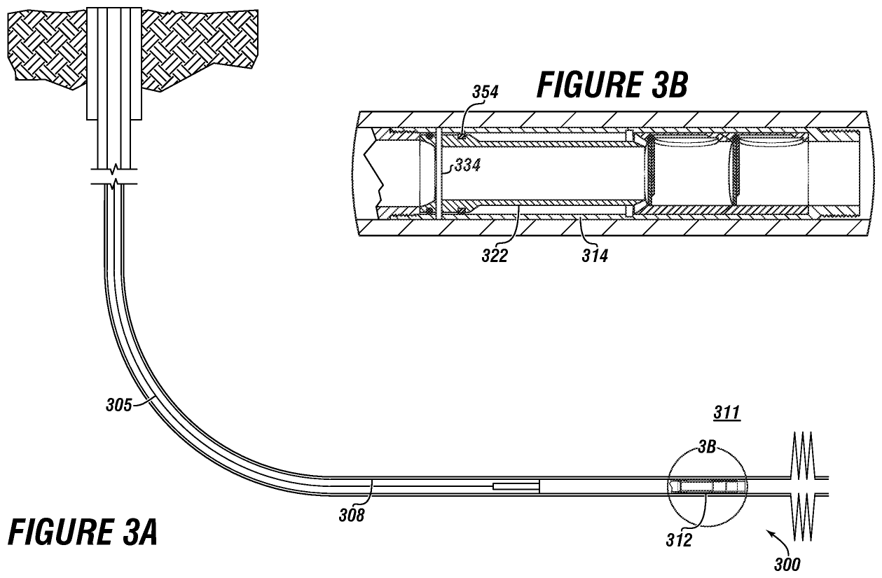

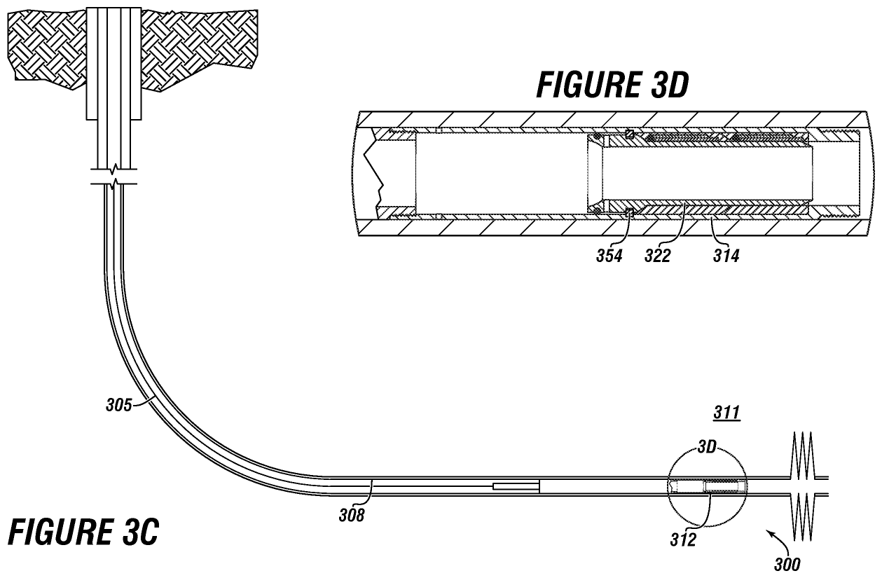

Referring now to FIGS. 3A-3D together, a side view of a production system having a flow control tool in a closed position, a close-up side view of the flow control tool of FIG. 3A, a side view of a production system having a flow control tool in an open position, a close-up side view of the flow control tool of FIG. 3C, illustrative of embodiments disclosed herein, are shown.

FIGS. 3A-3D together show an oilfield production system or operation 300 using a flow control tool 312. The flow control tool 312 may be part of a workstring 305 (e.g., e-line, wireline, coiled tubing, tube string, production string, etc.), as applicable.

Although not limited to any particular use, the tool 312 may be used in part of a work string 305 that initially has a drill bit (not shown here) on the end, and is operable to drill out plugs or other blockages. Once the last blockage is reached, one or more mechanisms may be activated in a manner known to one of skill in the art to drop the drill bit from the end of the workstring 305, thus allowing (formation) fluid to enter the workstring 305.

The flow control tool 312 may be activated or otherwise used in a manner to control, facilitate, etc. flow through the workstring 305 to the surface. While it need not be exactly the same, flow control tool 312 may be assembled, run, and operated as described herein and in other embodiments (such as for tool 212, and so forth), and as otherwise understood to one of skill in the art. Components of the tool 302 may be arranged and disposed as described herein and in other embodiments, and as otherwise understood to one of skill in the art. Thus, tool 312 may be comparable or identical in aspects, function, operation, components, etc. as that of other tool embodiments disclosed herein. Similarities may not be discussed for the sake of brevity.

The flow control tool 312 may include a (tool) body 314 made of a material known to be useful in downhole conditions, such as metal or composite. In embodiments, the body 314 may be made of 4140 carbon steel, or an otherwise heat-treated metal.

The body 314 may have a flowbore 320 therethrough. As such, in embodiments, the body 314 may be a hollow tubular configured for coupling with the workstring 305, whereby a fluid may (e.g., bi- or unidirectionally) flow through.

Accordingly, the body 314 (or tool 312) may have one or more subcomponents, including being disposed therein or otherwise associated therewith. As shown, the tool 312 may include a sliding sleeve 322. The sliding sleeve 322 may be insertable, and thus releasably coupled with the body 314.

The sliding sleeve 322 may be tubular in nature, but need not be limited. Generally, the sliding sleeve 322 may be configured in a manner whereby the sleeve 322 may be slidable with respect to the body 314. The sliding sleeve 322 may have a sleeve bore (with a sleeve bore inner diameter). The sleeve bore inner diameter may be in a bore ID range of about 1.0 inches to about 2.5 inches. In embodiments, the range may be about 1.8 inches to about 2.0 inches. In other embodiments, the inner diameter may be about 1.9 inches.

The sliding sleeve may have a ball seat (profile) formed thereon, which may be proximate or at a first sleeve end. The ball seat may be configured to receive a (drop) ball (not shown here).

The sliding sleeve 322 may be disposed within the flowbore 320 (and thus within the body 314). The sliding sleeve 322 may be slidable, movable, etc. with respect to the body 314. In a first or assembled position, the sliding sleeve 322 may be held in place, albeit releasably coupled with the body 314. The first position may include one or more activation members 334 coupled between the body 314 and the sliding sleeve 322, whereby the sleeve 322 may be sufficiently held in place. In this respect, the tool 312 may be considered to be in a (valve-) closed position.

The activation member 334 may be configured to break upon incurring a predetermined activation load. For example, the activation member 334 may be configured to break when the predetermined load is in a load range of about 1000 psi to about 5000 psi. The activation member 334 may be single load, double load, etc. Meaning the same member 334 may feel load at only a single break point, two break points (because of extending across the tool body), etc. There may be a plurality of activation members 334. The activation members 334 may be configured to break, shear, etc. The activation member 334 may be a shear pin or comparable.

The load may occur from fluid pressure Fp (not shown here, but typically from the surface or above the tool 312) being urged against the ball (surface). Pressure Fp may be increased until the pressure is in a fluid pressure range of about 1000 psi to about 5000 psi. In embodiments, the activation load may be about 2000 psi. The load may be transferred to, or otherwise felt by, the activation member 334. In embodiments, the sleeve 322 may not move until the fluid pressure Fp results in an activation load in excess of the predetermined activation load. Once that point is reached, the activation member 334 may break, and the sleeve 322 may be urged to slide toward and engage with an at least one flapper insert 336.

In embodiments, the sliding sleeve 322 may be in a first position that may entail being releasably coupled with the body 314 via the activation member 334. In embodiments, the sliding sleeve 322 may be in a second position that may entail being coupled with the body 314 via a retaining member 354.

In the first position the retaining member 354 may be in compacted position that may facilitate the movability of the sleeve 322. The retaining member 254 may have sufficient resiliency and flexibility to be accommodate being compacted at the outset, and then expand or otherwise move into a body groove (while still being at least partially in a sleeve groove).

When the sleeve 322 is in the second position, the retaining member 354 may expand or otherwise engage (move into contact with, etc.) the body 314. As such, the sleeve 322 may now be held in place in the second position via the retaining member 354 being configured to hold the sleeve 322 while being coupled with the body 314. The second position may entail a locked position, whereby with the sleeve 322 held in place, the tool 312 may be locked open. Thus, the tool 312 may be considered to be in an (valve-) open position.

This may occur because the sleeve 322 may be sufficiently urged down to a degree to compel the flapper to open. In some embodiments, there may be a plurality of flappers, any of which configured to be open (and held open) upon engagement thereof by the sleeve 322.

As a result of being locked open and in place, the tool 312 (or any of its components) need not be removed and/or flown back to the surface—production may commence. Production may be readily improved as a result of the presence of a larger ID through the tool.

Embodiments herein pertain to a method of operating or otherwise using a flow control tool as described herein. The method may include the use of a flow control tool like that as described herein, in other embodiments, or obvious variants (such as for tool 212, 312, and so forth), and as otherwise understood to one of skill in the art. Components of the tool may be arranged and disposed as described herein and in other embodiments, and as otherwise understood to one of skill in the art. Thus, tool may be comparable or identical in aspects, function, operation, components, etc. as that of other tool embodiments disclosed herein. Similarities may not be discussed for the sake of brevity.

The method may include running or otherwise providing a workstring, tubestring, or the like into a wellbore. The tool may include: a body; a sliding sleeve; an at least one activation member; and at least one flapper insert; and a retaining member.

The body may have a first body end, a second body end, a flowbore. The flowbore may extend therebetween. The body may have an annular inner body groove disposed on an inner body surface.

The sliding sleeve may be disposed within the flowbore. The sliding sleeve may, at the outset of assembly and prior to running, be releasably coupled with the body. The sliding sleeve may be movable to a locked position. The sliding sleeve may have a ball seat formed therein.

The at least one activation member may be coupled with the sliding sleeve in a manner to keep the sleeve releasably connected with the body. The activation member may be configured to break once an activation load is reached. In embodiments, there may be a plurality of activations members, such as in the range of 2 to 6.

The flapper insert may include a movable flapper biased to a first flapper position.

The retaining member may be disposed around the sliding sleeve. The retaining member configured to maintain the sleeve in the locked position once it has been moved by a force.

The method may include flowing a drop ball through the tubestring to an engagement position with the ball seat.

The method may include providing sufficient enough fluid pressure (such as via a pump or other mover) against the drop ball (once it has seated) in order to reach the activation load on the at least one activation member. As a result, breaking the at least one activation member, wherein upon breaking, the sliding sleeve may move to the locked position, and also resulting in the movable flapper being moved to a second (open) flapper position.

The method may include disengaging or otherwise removing the drop ball from the ball seat, or waiting (allowing) for the same to happen through ordinary sequence, whereby the fluid is now able to flow through the flow control tool, while the sliding sleeve remains in the locked position. This may occur, for example, by the ball (at least partially) dissolving, and thus dislodging from the ball seat. Additionally or alternatively, a pressure below the tool being adequate to overcome the seating pressure, and urge the ball out of the seat.

In aspects, the activation load may be in a load range of about 1000 psi to about 5000 psi. The flow control tool may include an at least one more or a second activation member. The activation member(s) may be shear pins, as would be understood by one of skill in the art. The drop ball may be made of a dissolvable material. The sliding sleeve may have an inner sleeve ID in an ID range of about 1.8 inches to about 2.0 inches.

The flow control tool may include a second flapper insert, which may be comparable or identical to the first flapper insert. The flapper insert (or in embodiments, the second flapper insert) may be engaged with an inner shoulder formed in the sliding sleeve. This may be especially so when fluid pressure urges the sleeve into contact therewith.

### Advantages

Embodiments of a flow control tool for a production operation of the present disclosure may provide for an increase in flow and/or reduced pressure drop promoted by the presence of a wider ID. Reduced pressure means mitigated or eliminated solids formation within the control tool, as well as less strain on pumping equipment and lower energy costs.

A synergistic effect is realized because a more effective flow control tool means faster production. And even a small savings in production time of a single well (repeated for multiple wells) results in an enormous savings on an annual basis.

While preferred embodiments of the disclosure have been shown and described, modifications thereof may be made by one skilled in the art without departing from the spirit and teachings of the disclosure. The embodiments described herein are exemplary only and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the present disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A flow control tool for use in a wellbore, the flow control tool comprising:
a body having a first body end, a second body end, a flowbore extending therebetween, and an annular inner body groove disposed on an inner body surface;
a sliding sleeve disposed within the flowbore, and configured with a ball seat, the sliding sleeve being initially releasably connected with the body, and movable to a locked position;
an at least one activation member coupled with the sliding sleeve in a manner to keep the sleeve releasably connected with the body, and being configured to break once an activation load is reached;
an at least one flapper insert disposed within the body, and further comprising a movable flapper biased to a first flapper position;
a retaining member disposed around the sliding sleeve, the retaining member configured to maintain the sleeve in the locked position,
wherein when the activation load is in a predetermined activation range, the at least on activation member breaks, thereby allowing the sliding sleeve to move toward the locked position, and wherein the locked position further comprises the retaining member expanded into the inner body groove, and the movable flapper held open in a second flapper position.

2. The flow control tool of claim 1, wherein the predetermined activation range comprises a pressure of about 1000 psi to about 5000 psi.

3. The flow control tool of claim 1, wherein the flow control tool further comprises a second activation member, and wherein the at least one activation member and the second activation member are shear pins.

4. The flow control of claim 1, the flow control tool further comprising a second flapper insert.

5. A production system comprising:
a tubestring disposed in a wellbore, and configured for a production fluid to flow therethrough;
a flow control tool coupled with the tubestring, the flow control tool comprising:
a body having a first body end, a second body end, a flowbore extending therebetween, and an annular inner body groove disposed on an inner body surface;
a sliding sleeve disposed within the flowbore, and configured with a ball seat, the sliding sleeve being initially releasably connected with the body, and movable to a locked position;
an at least one activation member coupled with the sliding sleeve in a manner to keep the sleeve releasably connected with the body, and being configured to break once an activation load is reached;
an at least one flapper insert disposed within the body, and further comprising a movable flapper biased to a first flapper position;
a retaining member disposed around the sliding sleeve, the retaining member configured to maintain the sleeve in the locked position,
wherein when the activation load is in a predetermined activation range, the at least on activation member breaks, thereby allowing the sliding sleeve to move toward the locked position, and wherein the locked position further comprises the retaining member expanded into the inner body groove, and the movable flapper held open in a second flapper position.

6. The production system of claim 5, wherein the predetermined activation range comprises a pressure of about 1000 psi to about 5000 psi.

7. The production system of claim 5, wherein the flow control tool further comprises a second activation member, and wherein the at least one activation member and the second activation member are shear pins.

8. The production system of claim 5, the flow control tool further comprising a second flapper insert.

9. A method of producing a fluid from a wellbore, the method comprising:
running a tubestring into the wellbore, the tubestring having an at least one flow control tool comprising:
a body having a first body end, a second body end, a flowbore extending therebetween, and an annular inner body groove disposed on an inner body surface;
a sliding sleeve disposed within the flowbore, and configured with a ball seat, the sliding sleeve being initially releasably connected with the body, and movable to a locked position;
an at least one activation member coupled with the sliding sleeve in a manner to keep the sleeve releasably connected with the body, and being configured to break once an activation load is reached;
an at least one flapper insert disposed within the body, and further comprising a movable flapper biased to a first flapper position; and
a retaining member disposed around the sliding sleeve, the retaining member configured to maintain the sleeve in the locked position,
flowing a drop ball through the tubestring to an engagement position with the ball seat;
providing sufficient enough fluid pressure against the drop ball in order to reach the activation load on the at least one activation member, and thus breaking the at least one activation member, wherein upon breaking, the sliding sleeve moves to the locked position, further resulting in the movable flapper being moved to a second flapper position;
disengaging the drop ball from the ball seat, whereby the fluid is now able to flow through the flow control tool, while the sliding sleeve remains in the locked position.

10. The method of claim 9, wherein the activation load comprises a load range of about 1000 psi to about 5000 psi.

11. The method of claim 9, wherein the flow control tool further comprises a second activation member, wherein the at least one activation member and the second activation member are shear pins, wherein the drop ball is made of a dissolvable material, and wherein the sliding sleeve has an ID in an ID range of about 1.8 inches to about 2.0 inches.

12. The method of claim 9, the flow control tool further comprising a second flapper insert.

13. The method of claim 9, wherein the flapper insert is engaged with an inner shoulder formed in the sliding sleeve.
